(19) United States
(12) Patent Application Publication
(10) Pub. No.: US 2002/0019688 A1
(43) Pub. Date: Feb. 14, 2002

(54) Brake S-CAM positioning sensor system

(76) Inventors: John Mantini, Niagara On The Lake (CA); Ken Adams, Niagara On The Lake (CA); Sam Chia, St. Catharines (CA)

Correspondence Address: DENNISON ASSOCIATES, SUITE 301, 133 RICHMOND STREET WEST, TORONTO, ON, M5H 2L7, CA

(21) Appl. No.: 09/870,485

(22) Filed: Jun. 1, 2001

(30) Foreign Application Priority Data
Jun. 1, 2000 (CA) 2.310,476

(51) Int. Cl. G06F 19/00

(52) U.S. Cl. 701/29; 701/70

(57) ABSTRACT

The present invention relates to a brake monitoring system for trucks, tractors, trailers or buses (class 6, 7 & 8 vehicles) using air brakes. In particular the present invention provides apparatus to monitor the braking system and the brake pad S-CAM positioning comprising a positioning transducer which can convert the rotational movement of the brake cam shaft S-CAM to an electrical signal. This signal is used as the input to a microprocessor system for further analysis and comparison in determining the condition of the S-CAM operations. The transducer signal not only provides the S-CAM position, but the speed of rotation both in braking and release of the brakes. There are many variables that can change the brake shoe application from the source (actuator canister) to the S-CAM including brake drum wear, worn S-CAM bushing, brake pad wear, worn pins & rollers, brake drum failure expanse(cracked drum), worn slack adjusters, pinched airlines, worn or broken return springs, brake chamber diaphragm braking, faulty modulator valve and brake release. After analyzing the signal from the transducer with a microprocessor system some of the failure of the braking system can be detected. By comparing the signal from different wheels, the system can detect delays of applying brakes or delays of releasing brakes which also could be a failure condition of the air brake system.

### BACKGROUND OF THE INVENTION

1. Field of the Invention

This invention relates to all trucks, tractors, trailers or buses (class 6, 7 & 8 vehicles) using air brakes. In particular the present invention provides apparatus to monitor the braking system and the brake pad S-CAM positioning.

2. Description of the Prior Art

When compressed air is supplied to the brake chamber of air brakes on a vehicle, the air forces a chamber diaphragm to flex and force a chamber push rod outward. The push rod applies linear force to the arm of a slack adjuster. The spline end of the slack adjuster is installed on the brake cam shaft. Movement of the arm of the slack adjuster converts the linear force of the air chamber push rod into a torque which turns the brake cam shaft. The end of the brake cam shaft is formed into an S-CAM. Rotation of the S-CAM applies pressure to the brake shoes pushing them away from themselves and against the brake drum.

Free stroke is the amount of movement of the arm of the slack adjuster required to move the brake shoes against the drum. If the free stroke measurement is not adjusted properly, it can cause brake failure and malfunction. Synchronization of both air brake actuators is crucial for the brake effectiveness from opposing sides of an axle. It will forewarn the driver of restriction of movement or seizing of brake component parts.

Existing systems have a visual device to measure the free stroke movement, thus informing the operator of existing problems visually at the source. The source they depend upon is the length of the rod from the actuator canister. Many devices are used to measure the length of the chamber push rod for possible over stroke condition. These devices do not tell the operator the exact placement of the brake shoe relative to the hub. Therefore this information can be misconstrued as being correct.

The rotation of the S-CAM applies the final moment of inertia to be applied to the brake shoe. There are many variables that can change the brake shoe application from the source (actuator canister) to the S-CAM including brake drum wear, worn SCAM bushing, brake pad wear, worn pins & rollers, brake drum failure expanse(cracked drum), worn slack adjusters, pinched airlines, worn or broken return springs, brake chamber diaphragm braking, faulty modulator valve and brake release.

### SUMMARY OF THE INVENTION

It is an object of the invention to provide a device to monitor the placement of the brake shoe relative to the maximum travel to the drum.

It is a further object of the invention to provide a transducer which can convert the rotational movement of the brake cam shaft S-CAM to an electrical signal.

It is a further object of the invention to provide a means of monitoring synchronization of both air brake actuators from opposing sides of an axle.

It is a further object of the invention to provide a system to warn the operator of restriction of movement or seizing of brake component parts.

Thus in accordance with the present invention there is provided a positioning transducer which can convert the rotational movement of the brake cam shaft S-CAM to an electrical signal. This signal is used as the input to a microprocessor system for further analysis and comparison in determining the condition of the S-CAM operations. In a preferred embodiment the mechanical connection between the brake cam shaft and the transducer has a positive multi angle drive on both ends that allows shaft wear movement.

Further features of the invention will be described or will become apparent in the course of the following detailed description.

### BRIEF DESCRIPTION OF THE DRAWINGS

In order that the invention may be more clearly understood, the preferred embodiment thereof will now be described in detail by way of example, with reference to the accompanying drawings, in which:

FIG. 1 is a perspective view of a typical vehicle braking system having a brake cam shaft rotation transducer according to the present invention.

FIG. 2 is a side plan view of a typical brake chamber and slack adjuster.

FIG. 3 is a front plan view of a typical brake drum, brake shoe assembly.

FIG. 4 is a perspective view of a brake cam shaft rotation transducer assembly according to the present invention.

FIG. 5 is a side plan view of the brake cam shaft rotation transducer of FIG. 4 mounted on the end of the brake cam shaft.

FIG. 6 is an enlarged plan view of the drive shaft shown as part of the brake cam shaft transducer assembly of FIG. 4.

FIG. 7 is a schematic illustration of an brake cam monitoring system according to the present invention;

FIG. 8 is a schematic illustration of another embodiment of brake cam monitoring system according to the present invention;

FIG. 9 is a block diagram of a preferred embodiment of the fault recording CPUs and sensor CPUs comprising a networked microprocessor system according to the present invention;

FIG. 10 is a typical diagram of the angle of rotation of the S-Cam for applying and releasing the brakes;

FIG. 11 is a typical diagram of the angle of rotation of the S-Cam if the brakes not fully released;

FIG. 12 is a typical diagram of the angle of rotation of the S-Cam for applying and releasing the brakes comparing the speed of release between two wheels;

FIG. 13 is a typical diagram of the angle of rotation of the S-Cam for applying and releasing the brakes comparing the start of applying the brakes between two wheels;

FIG. 14 is a typical diagram of the angle of rotation of the S-Cam for applying and releasing the brakes comparing new and worn out brake pads.

### DETAILED DESCRIPTION OF THE PREFERRED EMBODIMENT

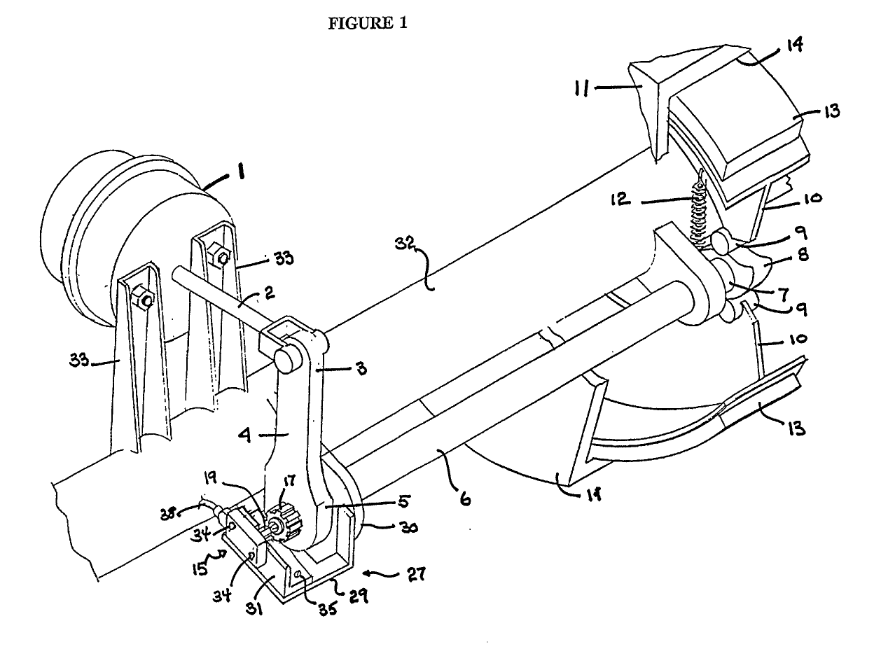

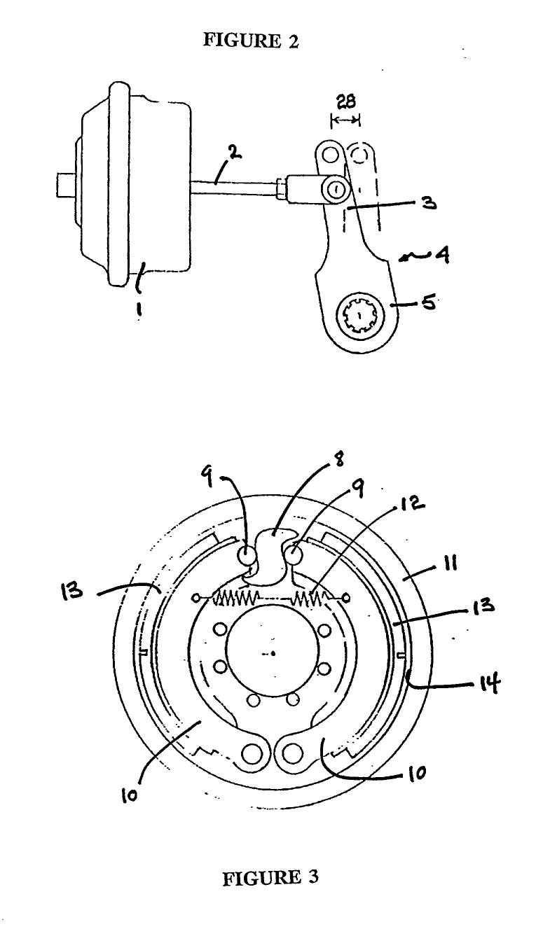

Referring to FIGS. 1 to 3 the operation of a typical air brake system can be described. The brake chamber 1 of air brakes is mounted on an axle 32 by brackets 33. When compressed air is supplied to the brake chamber 1 of air brakes on a vehicle (not shown), the air forces a diaphragm within the brake chamber 1 to flex and force a chamber push rod 2 outward (FIG. 2). The push rod 2 applies linear force to the arm 3 of a slack adjuster 4. The spline end 5 of the slack adjuster 4 is installed on the brake cam shaft 6. Movement of the arm 3 of the slack adjuster 4 by gear 17 converts the linear force of the air chamber push rod 2 into a torque which turns the brake cam shaft 6. The distal end 7 of the brake cam shaft 6 is formed into an S-CAM 8. As best illustrated in FIG. 3, rotation of the S-CAM 8 applies pressure to the rollers 9 attached to brake shoes 10 thereby pushing the brake shoes 10 away from themselves and against the brake drum 11 to apply the brakes. When the air is released, a return spring 12 causes the S-CAM to return to the original position thereby releasing the brakes.

The clearance between the lining material 13 on the brake shoe 10 and the mating surface 14 of brake drum 11 increases over time due to wear of the lining material 13. In addition wear of the S-CAM 8 and rollers 9 can result in a loss of brake effectiveness.

To overcome the problems of present visual systems which focus on the linear movement of the push rod 2 the present invention utilizes a sensor generally indicated at 15 in FIG. 1 and FIGS. 4 and 5 to monitor the rotation of the brake cam shaft 6. The sensor 15 according to the present invention comprises a positioning transducer 16 which can convert any angular movement of the brake cam shaft 6 to an electrical signal. This signal by output line 38 can be used for the input of a microprocessor system for further analysis and comparison in determining the condition of the S-CAM operations.

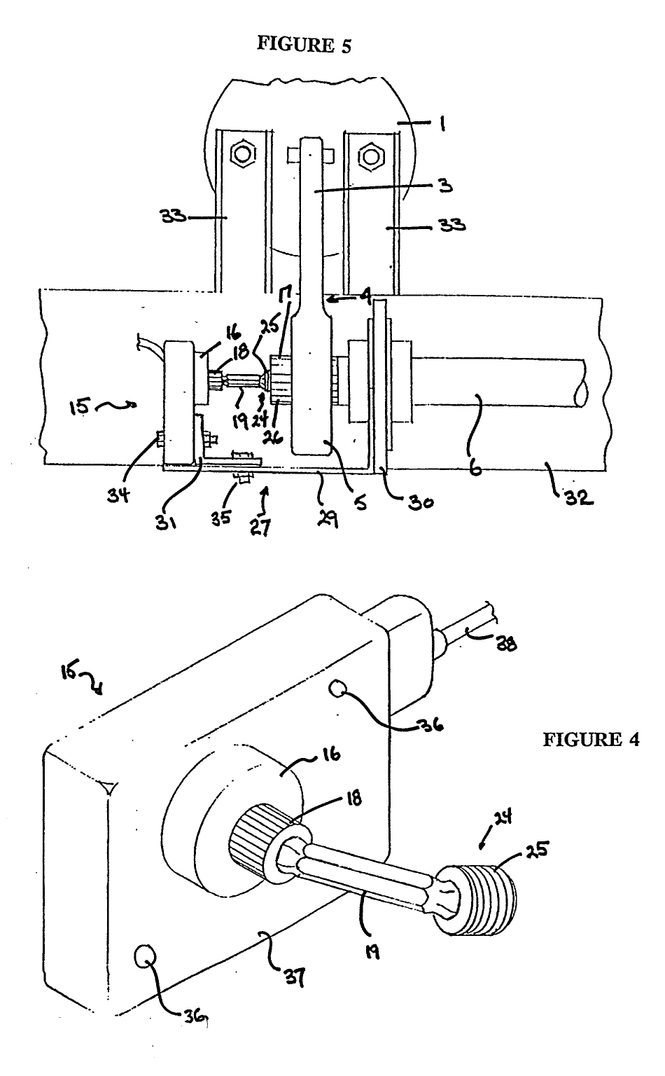

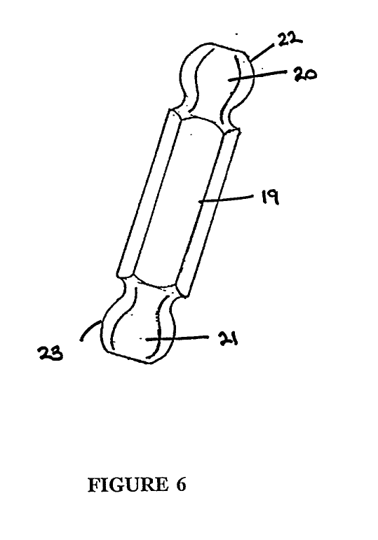

In the preferred embodiment illustrated in FIG. 4 the sensor 15 comprises a brake cam shaft rotation transducer assembly, which consists of a transducer 16 having a rotational drive input 18. In the embodiment illustrated the drive input 18 has a hex configuration. Drive shaft 19 has a corresponding hexagonal cross-section. The ends 20, 21 of drive shaft 19 are slightly rounded at edges 22, 23 to permit the drive shaft 19 to rotationally engage the drive input 18 on the transducer 16 and the output 24 on the brake cam shaft 6. The output 24 on the brake cam shaft 6 in the preferred embodiment illustrated comprises an alien key 25 tapped, screwed and/or broached into the end 26 of the brake cam shaft 6. The end 21 of the drive shaft 19 is rotationally engaged within the allen key 25. With this configuration the mechanical connection between the brake cam shaft 6 and the transducer 16 has a positive multi angle drive on both ends of the drive shaft that provides some flexibility and allows brake cam shaft wear movement and thereby avoid damage to the transducer.

The sensor 15 is mounted to the end 26 of brake cam shaft 6 by means of an adjustable bracket assembly 27. The bracket assembly 27 consists of a first L-shaped bracket 29 mounted by screws, bolts or other suitable fastener to the cam shaft bracket 30. A second L-shaped bracket 31 is adjustably connected to the first bracket 30 by adjustment bolts 35. The sensor 15 is mounted to the second bracket 31 by screws or bolts 34 through holes 36 in sensor housing 37. One end 20 of drive shaft 19 is inserted into the drive input 18 on transducer 16. The other end 21 of the drive shaft 19 is inserted into the output 24 on the brake cam shaft 6. The bracket 31 is adjusted relative to bracket 29 by adjustment 35 so that the drive shaft 19 cannot fall out of drive input 18 on transducer 16 and output 24 on the brake cam shaft 6 but still turn freely. A shroud or sleeve (not shown) can be placed around the drive shaft 19 to prevent accidental removal or for safety purposes.

The brake cam rotation sensor (transducer) 16 converts the rotational movement of the brake cam shaft 6 by an electrical signal proportional to the rotational degree of movement 28 of the arm of the slack adjuster. In effect the transducer signal will not only provide the S-CAM position, but the speed of rotation both in braking and release of the brakes. As noted above, there are many variables that can change the brake shoe application from the source (actuator canister) to the S-CAM including brake drum wear, worn S-CAM bushing, brake pad wear, worn pins & rollers, brake drum failure expanse(cracked drum), worn slack adjusters, pinched airlines, worn or broken return springs, brake chamber diaphragm braking, faulty modulator valve and brake release. After analyzing the signal from the transducer with a microprocessor system some of the failure of the braking system can be detected. By comparing the signal from different wheels, the system can detect delays of applying brakes or delays of releasing brakes which also could be a failure condition of the air brake system.

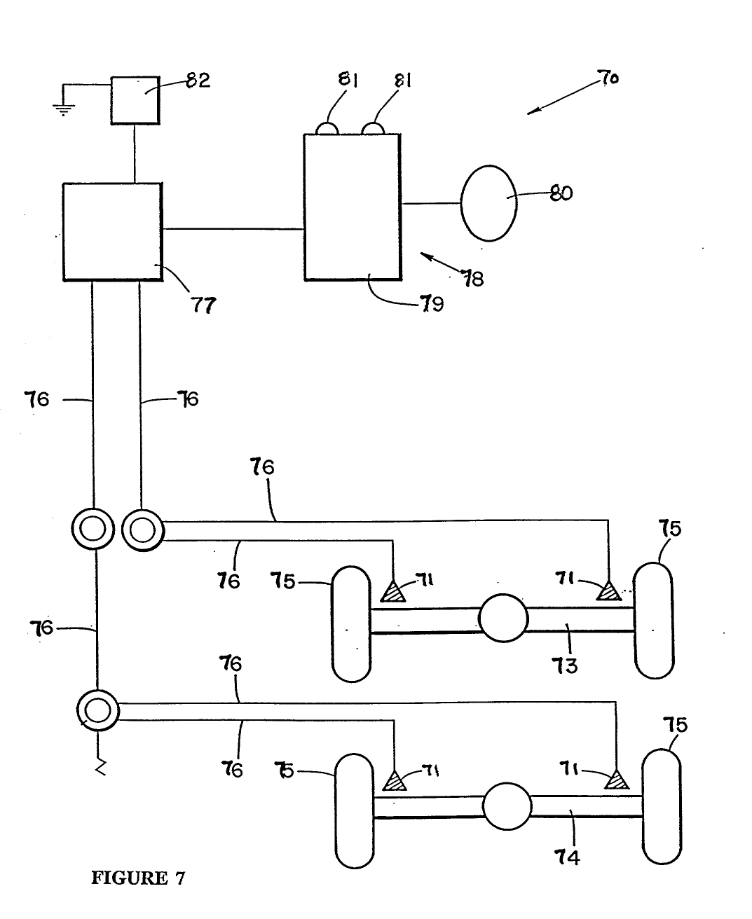

One embodiment of a brake cam monitoring system of the present invention for use on the axles of a vehicle, particularly heavy highway vehicles, is schematically illustrated in FIG. 7. The brake cam monitoring system, generally indicated at 70, in its simplest form comprises one or more individual brake cam positioning sensors 71 which are capable of monitoring the rotation of the brake cam shaft. The brake cam positioning sensors 71 are located on each individual axle 73 and 74. Wheels 75 are located at the end of each of the axles. The sensors 71 are connected by individual output lines 76 to a programmable micro processor 77. The micro processor 77 receives the information signal or data from the sensors 71. This information is in the form of voltage and resistance change. The micro processor 77 is programmable so that when a change in voltage and resistance reaches specified parameters the micro processor 77 determines an alarm condition is present and that data is sent to the alarm means 78. The micro processor 77 and/or alarm means 78 can either be separate pieces of equipment, may be combined in one device. Alternatively the alarm means 78 may be an already existing component on the vehicle that can be programmed to deal with the data from the sensors 71 and or the micro processor 77. The alarm means 78 preferably comprises an audio visual micro processing annunciator 79 which will alert the operator of the vehicle by alarm means 80 of the alarm condition: i.e. brake drum wear, worn S-CAM bushing, brake pad wear, worn pins & rollers, brake drum failure expanse (cracked drum), worn slack adjusters, pinched airlines, worn or broken return springs, brake chamber diaphragm braking, faulty modulator valve and brake release. The alarm 80 may be in the form of an LED display, lights, buzzer, or other visual or audio display device or combination of same.

A reset button 81 is preferably provided in association with the alarm means 78 that will enable the operator to confirm the alarm condition.

The system can be powered as an auxiliary on the fuse box 82 and draws from the vehicle's electrical power supply system. A back up system can be provided such as a rechargeable battery etc.

By utilizing a digital programmable microprocessor 77 the system can be capable of storing in memory the data from the sensors 71 for inspection purposes to help determine the cause of detachment. Further a digital key pad can be provided to enable the operator to isolate specific sensors and/or perform other functions if required.

When the brake is applied the linear movement of the push rod is converted to the degree of the rotation of the S-CAM. The micro-processing system measures degrees of rotation and calculates the change of the angle (delta of the angle). The delta change is compared by a predetermined threshold level and if that level exceeds that threshold by some amount, it creates a fault condition (brake out of adjustment). This condition is reported to the driver in both audio and visual means and reports the location of the fault (eg. Axle 2 left wheel). Mechanical defects and brake wear can result in these alarm conditions.

By measuring the angle of release and comparing with the applied brakes if the angle is irregular or less than the initial position of the S-CAM this indicates some failure in brake releasing performance. Numerous mechanical defects can lead to that condition, which can be reported to the operator by both a visual and audio means.

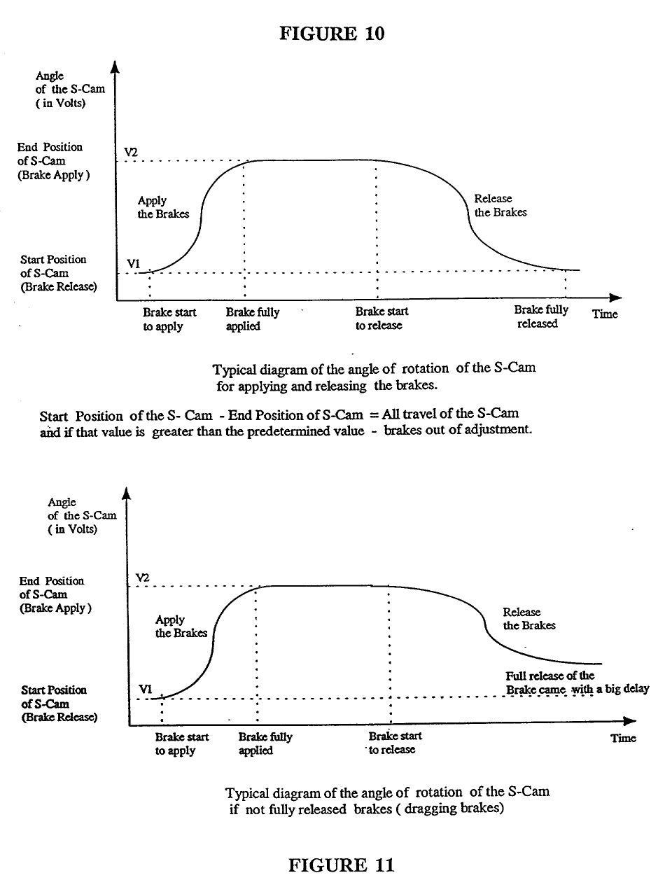

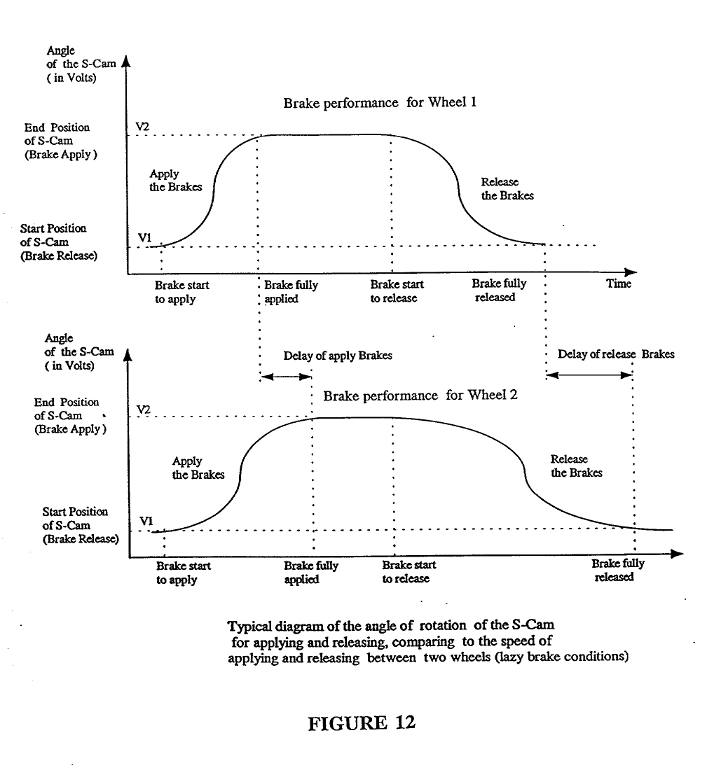

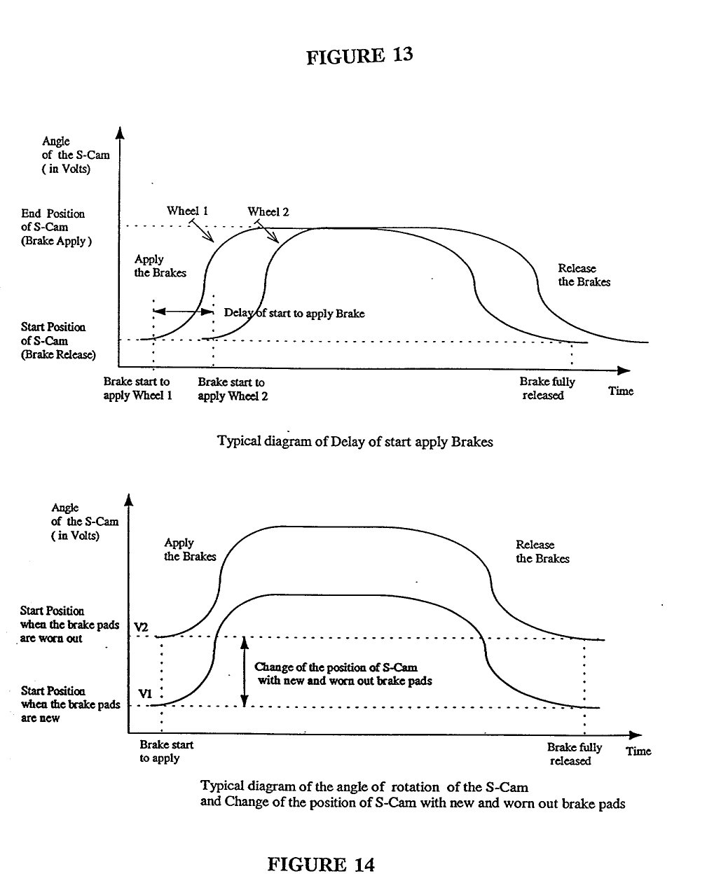

The speed of the S-CAM application and release is defined by the change of the angle over the change of the time. By comparing the speed of applying and releasing brakes, the system can determine the imbalance in other wheel brake assemblies. (see FIGS. 10 - 13) Detection of a lazy applying or release can be reported to the operator by both visual and audio means.

After a predetermined changing of the S-CAM rotation maximum brake pad wear can be determined by a present threshold (see FIG. 14). Brake chamber size or length of push rod will not effect performance of the S-CAM positioning sensor or the whole system.

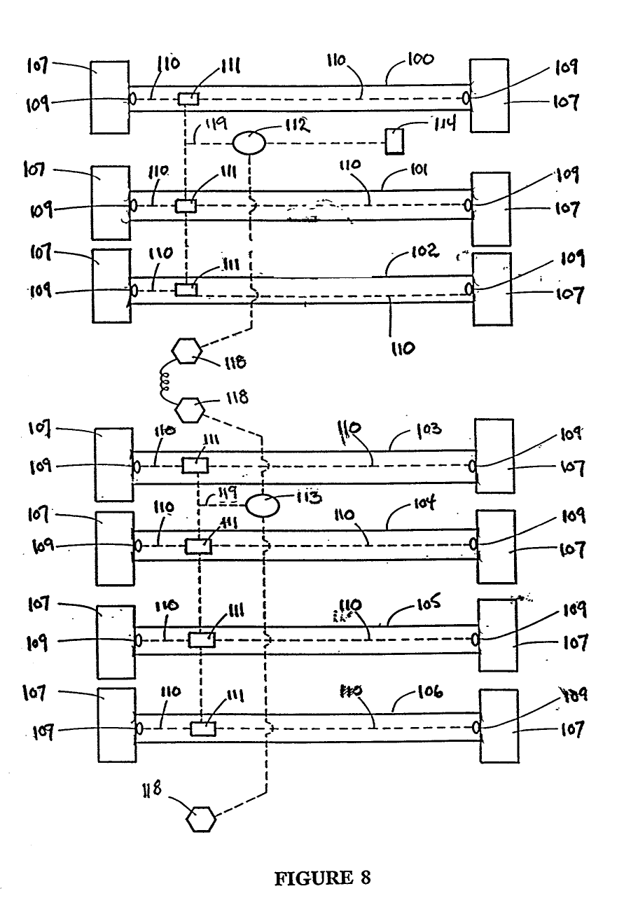

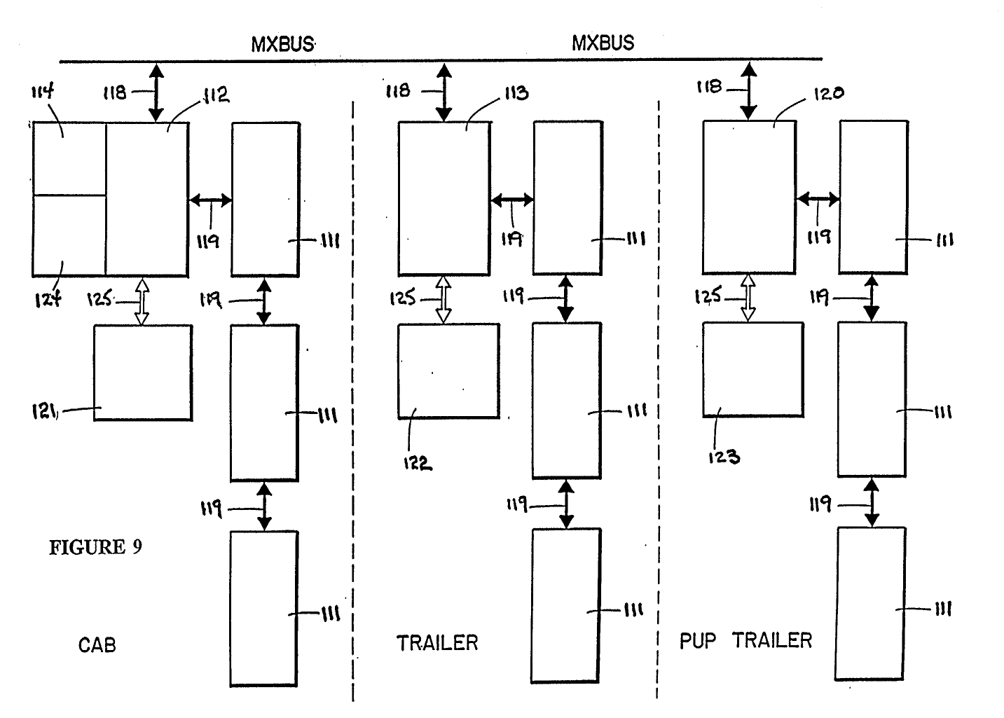

Another embodiment of the invention comprising a networked micro-controller based system that monitors and records brake cam positioning faults for a multi axle vehicle and in particular a cab and trailer hookup is schematically illustrated in FIGS. 8 and 9. FIG. 8 illustrates the front axle 100 and rear axles 101, 102 of a vehicle cab and axles 103, 104, 105 and 106 of a trailer. Wheel assemblies 107 are located at the ends of each of the axles 100 to 106. The wheel assemblies 107 can be either single wheels as typically found on the front axle 100 or dual wheels as typically found on axles 101 to 106. Brake cam positioning sensors 109, capable of monitoring the rotation of the brake cam shaft are located on each axle. The sensors 109 on each axle are connected by individual output lines 110 to a sensor module CPU (SMC) 111 located in proximity to each of the axles. The cab and trailer are each also equipped with a fault recording CPU (FRC), 112 and 113 respectively, that communicates with the sensor module CPU 111 for each axle of the cab or trailer respectively. The FRC 112 in the cab has an additional keypad and display used for system initialization and to provide a fault warning system 114 to alert the driver of any axle problems.

In the preferred embodiment the FRCs, 112 and 113, communicate with each other on a multiplex bus (MXBUS) 118 that uses a wire connected to one of the pins on the standard seven pin connector between the cab and trailer for transmitting and receiving data. This is accomplished by pulsing a high frequency carrier on the selected wire. Dual frequencies are used, one for receive, one for transmit to allow for full duplex communication on the single wire. In the preferred embodiment a turn signal lamp wire is selected. The frequency carriers are low voltage, and are detectable even if the signal lamp is pulsing and will not interfere with the turn signals. The MXBUS is a three conductor bus, one for signal, one for signal corn, one for power. These conductors can be found on all truck harnesses that provide the center power pin for an auxiliary circuit or power for the ABS brakes. For older equipment, the trailer will have to be equipped with a standard lead-acid battery to power the fault recording CPU. This battery could be charged by having the running lights activated for a period of time.

As best illustrated in FIGS. 8 and 9, all FRCs, 112 and 113, communicate with their own local SMC 111 via a sensor module bus (SMBUS) 119. The SMBUS is preferably a four conductor bus utilizing the RS-485 interface standard. This interface standard implements a balanced multi-point transmit/receive communication line used in a party line configuration. This allows the cab FRC 112 to connect to the SMC on axle 100, the SMC on axle 100 to the SMC on axle 101 and the SMC on axle 101 to the SMC on axle 102. The trailer FRC 113 connects to the SMC on axle 103, the SMC on axle 103 to the SMC on axle 104, the SMC on axle 104 to the SMC on axle 105 and so on to the last trailer axle. This feature reduces the amount of wiring harness along the bottom of the cab or trailer.

If a pup trailer is hooked up to trailer a similar arrangement is utilized. The sensors on each axle are connected by individual output lines to a sensor module CPU (SMC) 111 located in proximity to each of the axles on the pup trailer. The pup trailer is also equipped with a fault recording CPU (FRC) 120 that communicates with the sensor module CPU for each axle of the pup trailer. The pup trailer FRC 120 communicates with FRCs in the cab 112 and on the trailer 113. As noted in the preferred embodiment all the FRCs communicate with each other on a multiplex bus (MXBUS) 118 that uses a free turn signal lamp wire for transmitting and receiving data.

The sensors 109 are connected by individual output lines 110 to a sensor module CPU 111 located in proximity to each of the axles. The sensor module CPUs are preferably attached to the frame of the cab and trailer(s). As shown in FIG. 3 the cab, trailer and pup trailer if any are each also equipped with its own fault recording CPU (FRC)112, 113 and 120 respectively, that communicates with the sensor module CPU for each axle of the cab or trailer or pup trailer. The FRC 112 in the cab may have an additional keypad and display 114 used for system initialization and to provide a fault warning system to alert the driver of any axle problems. Each FRC 112, 113 and 120 is also equipped with an interrogation interface 121, 122 and 123 respectively for connection to a hand held terminal or lab top computer. This feature allows interrogation of isolated trailers as well as cab/trailer hookups.

The FRC 112 in the cab has a real-time clock 124 for logging date and time of occurring faults. During initialization of a cab/trailer hookup, the cab FRC 112 will transfer the current date and time to the FRC 113 for the trailer and the FRC 120 for the pup trailer if any. When the cab FRC 112 receives faults from the trailer FRCs 113, 120, it will respond by sending back the date and time for storage in the trailer FRC EEProm. This eliminates the need for a battery backed-up read time clock on trailer FRC's 113, 120. The cab FRC 112, maintains battery power to the real time clock from the cab battery to maintain the time. The time and date can be reset and verified by the driver prior to initializing all trailers in the system should the cab battery be disconnected or fail in service.

Each Sensor Module CPU (SMC) 111 will monitor at least two brake cam positioning sensors 109 for each axle, one for each wheel. If any wheel generates a suspected fault, the fault code is transmitted by the SMC 111 to the FRC 112, 113 or 120 for further processing. The FRC is then responsible for verifying the fault is true by comparing to all other axles on the trailer/cab. If the fault is valid it is then hard recorded in the EEProm and passed on to the cab FRC 112 through a multiplexed connection (MXBUS) 118 for driver warning.

The FRC's 112, 113 and 120 can communicate with each other by a variety of known means. The FRC's could be connected by wire or co-axial cable however authorities are discouraging additional wire connections between the cab and trailer and restricting wire or cable to the current seven prong connection. Radio receivers and transmitters or cellular connections could be utilized however a reliable, secure interface without the possibility of outside interference or disruption is required.

As shown in FIGS. 8 and 9, in the preferred embodiment the FRC's, 112, 113 and 120, communicate with each other on a multiplexed connection (MXBUS) 118 that uses a circuit in the standard seven pin (J560 pin). As noted above in the preferred embodiment a free turn signal lamp wire is utilized for transmitting and receiving data. This is accomplished by pulsing a high frequency carrier on the turn signal wire. Dual frequencies are used, one for receive through a receiver, and one for transmit by transmitter to allow for full duplex communication on the single wire. These frequency carriers are low voltage, and are detectable even if the signal lamp is pulsing and will not interfere with the turn signals. The MXBUS is a three conductor bus, one for signal, one for signal corn, one for power. These conductors can be found on all truck harnesses that provide the center pin for power to the ABS brakes. For older equipment, the trailer will have to be equipped with a standard lead-acid battery to power the fault recording CPU, this battery could be charged by having the running lights activated for a period of time.

By utilizing a multiplexing connection between the cab and trailer, it is possible to incorporate a number of programmable auxiliary features into the system. In addition the system can be programmed so that the operator can control from the cab: lift axle operation, operate rear door locks, operate emergency stop warning lights on the trailer, operate tail gates, hoppers, valves and chutes, operate back up lights and horn on the trailer. The operator can also from the cab monitor: drive shaft overheating, trailer refrigeration units, load shift or weight of the trailer and the like.

All FRC's communicate with their own local SMC's via a sensor module bus (SMBUS) 119. The SMBUS 119 is preferably a four conductor bus utilizing the RS485 interface standard. The SMBUS includes a transmitter and receiver at the FRC and corresponding transmitter and receiver at the SMC. This interface standard implements a balanced multi-point transmit/receive communication line used in a party line configuration. This allows the FRC 112 to connect to SMC 111 on axle 100, SMC 111 on axle 101 to SMC 111 on axle 102 and so on to the last axle. This feature reduces the amount of wiring harness along the bottom of the cab or trailer.

As shown in FIGS. 9, all the FRC's 112, 113 and 120 communicate with their corresponding Interrogate Terminal 121, 122 and 123 via an interrogate bus (ITGBUS) 125. This bus preferably uses a standard three conductor RS232 communication protocol, which is available on all standard computer equipment. Again the ITGBUS includes a transmitter and receiver. An extra power plug will be provided by the Interrogate Terminal for connection to a trailer FRC which may be isolated with no existing power.

Having illustrated and described a preferred embodiment of the invention and certain possible modifications thereto, it should be apparent to those of ordinary skill in the art that the invention permits of further modification in arrangement and detail. For example the attachment between the transducer and S-CAM, the placement of the transducer and the kind of transducer either optical, encoder, magnetic, hydraulic, air flow or displacement sensor. All such modifications are covered by the scope of the invention.

The embodiments of the invention in which an exclusive property or privilege is claimed are defined as follows:

1. Apparatus to monitor the rotation of the brake cam shaft comprising a sensor which can convert the rotational movement of the brake cam shaft S-CAM to an electrical signal.

2. Apparatus according to claim 1 wherein said electrical signal is used as the input to a microprocessor system for further analysis and comparison in determining the condition of the S-CAM operations.

3. Apparatus according to claim 1 or 2 wherein a mechanical connection between the brake cam shaft and the transducer comprises a positive multi angle drive on both ends that allows shaft wear movement.

4. Apparatus according to claim 1, 2 or 3 wherein said sensor is a brake cam shaft rotation transducer assembly which can convert any angular movement of the brake cam shaft to an electrical signal.

5. Apparatus according to claim 4 wherein said brake cam shaft rotation transducer assembly consists of a transducer having a rotational drive input, a drive out put on the brake cam shaft and a drive shaft rotationally engaged between the drive input on the transducer and the drive output on the brake cam shaft.

6. Apparatus according to claim 5 wherein the mechanical connection between the brake cam shaft and the transducer has a positive multi angle drive on both ends of the drive shaft that provides some flexibility and allows brake cam shaft wear movement to avoid damage to the transducer.

7. Apparatus according to claim 4 or 5 wherein the brake cam shaft rotation transducer assembly is mounted to the end of brake cam shaft by means of an adjustable bracket assembly.

8. Apparatus according to claim 4 wherein the drive input has a hex configuration.

9. Apparatus according to claim 8 wherein said drive output has a corresponding hexagonal cross-section and the ends of said drive shaft are slightly rounded at the edges.

10. Apparatus according to claim 8 or 9 wherein said output drive on the brake cam shaft comprises an allen key tapped, screwed and/or broached into the end of the brake cam shaft.

11. Apparatus according to claim 10 wherein the end of the drive shaft is rotationally engaged within the alien key.

12. A brake cam monitoring system for monitoring the rotation of a brake cam shaft on vehicles equipped with air brakes, said system comprising one or more brake cam rotation sensors capable of converting the rotational movement of the brake cam shaft to an electrical signal, a programmable micro processor for receiving and processing the sensor signals to detect an alarm condition and alarm means to alert the driver of a problem with one or more of the brakes.

13. A brake cam monitoring system according to claim 12 wherein said micro processor monitors degree of movement of the brake cam shaft and the speed of rotation both on braking and releasing the brakes as detected by the sensors and determines when an alarm condition exists.

14. A networked micro-controller based system for monitoring and recording the rotation of a brake cam shaft for a multi axle vehicle where each of the axles on the vehicle has wheels and air brakes at both ends of said axles, said system comprising sensors capable of capable of converting the rotational movement of the brake cam shaft associated with said brakes mounted on each axle to an electrical signal, one or more sensor CPUs connected to the sensors monitoring the brakes, a fault recording CPU connected to said sensor CPUs, and a fault warning means.

15. A networked micro-controller based system according to claim 14 for monitoring and recording the rotation of a brake cam shaft for a heavy vehicle cab and trailer hookup, where said cab has at least two cab axles with wheels and brakes at both ends of said cab axles and said trailer has one or more trailer axles with wheels and brakes at both ends of said trailer axles, comprising sensors capable of converting the rotational movement of the brake cam shaft associated with said brakes mounted on each axle to an electrical signal associated with said axles, brakes and wheels mounted on each cab axle and each trailer axle, one or more cab sensor CPUs connected to the sensors monitoring the cab axles and wheels and brakes, one or more trailer sensor CPUs connected to the sensors monitoring the trailer axles and wheels and brakes, a cab fault recording CPU connected to said cab sensor CPUs, a trailer fault recording CPU connected to said trailer sensor CPUs, a fault warning means and means to permit the cab fault recording CPU and trailer fault recording CPU to communicate with each other.

16. A system according to claim 15 wherein the means to permit the cab fault recording CPU and trailer fault recording CPU to communicate with each other consists of a multiplex bus.

17. A system according to claim 16 wherein the multiplex bus uses one of the circuits on the standard seven pin connection between the cab and trailer for transmitting and receiving data.

18. A system according to claim 17 wherein the multiplex bus uses a free turn signal lamp wire for transmitting and receiving data.
